(19) United States
(12) Patent Application Publication
(10) Pub. No.: US 2025/0037481 A1
(43) Pub. Date: Jan. 30, 2025

(54) METHODS AND APPARATUS TO DETECT AND LOCATE OBJECTS IN THREE-DIMENSIONAL POINT CLOUDS

(71) Applicant: Intel Corporation, Santa Clara, CA (US)

(72) Inventors: Rita Chattopadhyay, Chandler, AZ (US); Atul Divekar, Folsom, CA (US)

(21) Appl. No.: 18/437,467

(22) Filed: Feb. 9, 2024

(51) Int. Cl. G06V 20/64; G06V 10/771; G06V 10/82

(52) U.S. Cl. CPC G06V 20/64; G06V 10/771; G06V 10/82

(57) ABSTRACT

Example systems, apparatus, articles of manufacture, and methods to detect and locate objects in three-dimensional (3D) point clouds are disclosed. Examples apparatus disclosed herein apply at least one of a template or a mask at a sample point of an overhead view of a 3D point cloud to identify a candidate cluster of points in the 3D point cloud, the candidate cluster to satisfy an occupancy target. Disclosed example apparatus also input the candidate cluster to a neural network, the neural network trained to output a feature vector for the candidate cluster. Disclosed example apparatus further process the feature vector to output parameters associated with an object classification and a bounding box for an object corresponding to the candidate cluster.

### FIELD OF THE DISCLOSURE

This disclosure relates generally to computer vision and, more particularly, to methods and apparatus to detect and locate objects in three-dimensional (3D) point clouds.

### BACKGROUND

In recent years, the use of light detection and ranging (LiDAR) sensors to implement computer vision for systems such as autonomous vehicles, robots, etc., has increased. One or more LiDAR sensors can be included in such systems to reflect laser beams off object(s) in an environment, which results in a 3D point cloud representative of a scene including the object(s). Detection of the object(s) from the 3D point cloud can involve objection classification to identify the object(s) and bounding box regression to locate the object(s).

### BRIEF DESCRIPTION OF THE DRAWINGS

FIG. 1 is a block diagram of an example object detector to detect and locate objects in 3D point clouds.

FIG. 2 is a block diagram of example cluster selection circuitry included in the example object detector of FIG. 1.

FIGS. 3-5 illustrate example masks and example templates utilized by the example cluster selection circuitry of FIGS. 1 and/or 2.

FIG. 6 is a block diagram of example bounding box generation circuitry and example regression calculation circuitry included in the example object detector of FIG. 1.

FIG. 7 is a block diagram of example mask generation circuitry and example template generation circuitry to generate the example masks and the example templates of FIGS. 3-5.

FIG. 8 illustrates example operation of the mask generation circuitry of FIG. 7 to generate an example mask to be utilized by the cluster selection circuitry of FIGS. 1 and/or 2.

FIGS. 9 and 10 are flowcharts representative of example machine readable instructions and/or example operations that may be executed, instantiated, and/or performed by example programmable circuitry to implement the object detector 100 of FIG. 1.

FIG. 11 is a block diagram of an example processing platform including programmable circuitry structured to execute, instantiate, and/or perform the example machine readable instructions and/or perform the example operations of FIGS. 9 and/or 10 to implement the object detector 100 of FIG. 1.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 9 and/or 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 15 illustrates example patterns utilized by the example cluster selection circuitry of FIGS. 1 and/or 2 for sample point selection.

In general, the same reference numbers will be used throughout the drawing(s) and accompanying written description to refer to the same or like parts. The figures are not necessarily to scale.

### DETAILED DESCRIPTION

LiDAR sensors are used in autonomous vehicles, robots and other systems and applications to obtain 3D point clouds of a scene. LiDAR sensors reflect laser beams off target object(s) in an environment, which results in a 3D point cloud representative of a scene including the object(s). The 3D point cloud is then processed to detect the object(s) for navigation, collision avoidance, grasping and moving the object(s), etc. However, the resulting 3D point clouds may include irregular non-continuous 3D samples having decreasing density with increasing distance from the LiDAR sensor. As such, detecting and locating objects in such 3D point clouds may be challenging, especially for objects located far away from the sensor.

Example object detectors, and/or other object detection methods, apparatus and articles of manufacture (e.g., computer readable storage media) are disclosed herein. Some such examples implement mask and/or template matching (e.g., on an overhead view) of a 3D point cloud to select candidate cluster(s) from the 3D point cloud as proposals for focusing object detection and location. In examples disclosed herein, the candidate cluster(s) are input to one or more neural networks and/or other machine learning architecture(s), which are trained to output object classification parameters to identify the object(s) represented by the candidate cluster(s). In examples disclosed herein, the one or more neural networks and/or other machine learning architecture(s) also output bounding box parameters to locate the detected object(s) represented by the candidate cluster(s). Some examples utilize an overhead view of the 3D point cloud for analyses. An overhead view is also referred to herein as a birds-eye view, a top-down view, etc., and corresponds to an overhead, or top-down, projection of the 3D point cloud onto a two-dimensional (2D) image, grid, etc.

Some example object detectors, and/or other object detection methods, apparatus and articles of manufacture (e.g., computer readable storage media) disclosed herein, also utilize mask and/or template matching (e.g., with overhead views, also referred to as birds-eye views, top-down views, etc.) of 3D point clouds to train the neural network(s) and/or other machine learning architecture(s). In some examples, the training data used to train the neural network(s) and/or other machine learning architecture(s) includes a training 3D point cloud with known, ground-truth (e.g., labeled) object(s) and bounding box(es). In some such examples, an overhead view of a training cluster from the training 3D point cloud is determined. Using the overhead view, a proposal bounding box is found that fits the points of the training cluster. The training cluster, the proposal bounding box and a ground-truth bounding box associated with the ground-truth object classification of the training cluster are then used to train the neural network(s) and/or other machine learning architecture(s) to carry out object classification and bounding box regression. This training process can be repeated with other training cluster(s) selected from the training 3D point cloud, and/or with training cluster(s) selected from other training 3D point clouds, until one or more criteria for halting training are satisfied, such as a number of training iterations, an error threshold, etc.

In the foregoing examples, object detection and location processing are focused on candidate cluster(s), which are smaller than the entire 3D point cloud. As a result, the dimensionality and complexity of the neural network(s) and/or other machine learning architecture(s) that implement the foregoing examples can be reduced relative to neural network(s) and/or other machine learning architecture(s) that process the entire 3D point cloud. Such reduction in dimensionality and complexity can reduce power consumption, reduce computational resource requirements, improve the rate at which objects are detected and located, etc. By focusing object detection and location processing on candidate cluster(s) instead of the entirety of the 3D point cloud, object classification and box regression accuracy can also be improved.

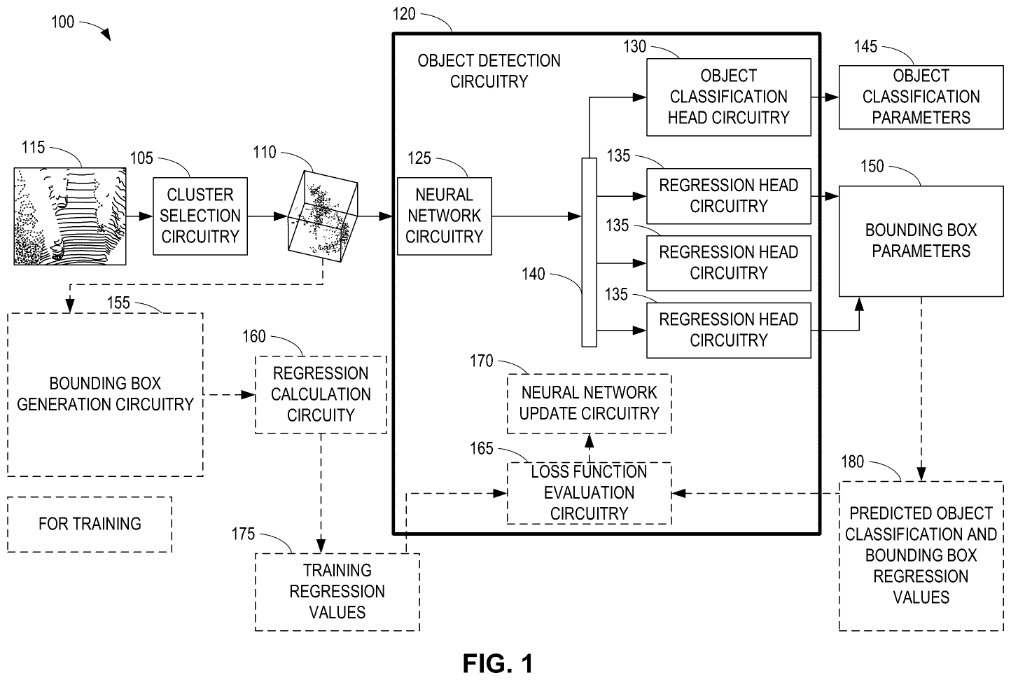

Turning to the figures, FIG. 1 is a block diagram of an example object detector 100 to detect and locate objects in 3D point clouds. The object detector 100 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the object detector 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example object detector 100 of FIG. 1 includes example cluster selection circuitry 105 to select one or more example candidate clusters 110 from an example input 3D point cloud 115. The object detector 100 of the illustrated example also includes example object detection circuitry 120 to process the candidate cluster(s) 110 to detect and locate one or more objects in the 3D point cloud 115. In the illustrated example, the 3D point cloud 115 is generated by one or more LiDAR sensors sampling an environment. As such, the 3D point cloud 115 includes points in 3D space that are representative of reflections off one or more objects in the environment. A point can be represented by location coordinates in 3D space, such as a pair of horizontal (e.g., x and y) coordinates, and a vertical (e.g., z) coordinate. However, the 3D point cloud 115 is not limited to a LiDAR point cloud. On the contrary, the 3D point cloud 115 can be any 3D point cloud generated in any manner. For example, the 3D point cloud 115 can be generated using visible light sensors (e.g., a camera) and a depth sensor (e.g., an infrared sensor). In some examples, the points of the 3D point cloud 115 also have one or more texture values that represent intensity, color, etc., of the different points.

The cluster selection circuitry 105 of the illustrated example implement mask and/or template matching on an overhead view of the 3D point cloud 115 to select the candidate cluster(s) 110. In some examples, a given candidate cluster 110 output by the cluster selection circuitry 105 is represented by a set of location coordinates corresponding to the points of the 3D point cloud 115 included in the candidate cluster 110. In some examples, the given candidate cluster 110 output by the cluster selection circuitry 105 also includes the intensity and/or normal values of the points included in the cluster 110. Further details concerning implementation and operation of the cluster selection circuitry 105 are provided below.

The object detection circuitry 120 of the illustrated example includes example neural network circuitry 125, example object classification head circuitry 130 and example regression head circuitry 135. In the illustrated example, the neural network circuitry 125 implements one or more neural networks and/or other machine learning architecture(s) trained to output an example feature vector 140 based on an input candidate cluster 110. In some examples, the neural network circuitry 125 implements a PointNet++ neural network or similar neural network, and/or an enhancement thereof. For example, the neural network circuitry 125 implements a neural network pipeline that employs hierarchical feature learning with multiple set abstraction levels. In some examples, each set abstraction level includes a sampling layer, a grouping layer and a mini-PointNet layer. The sampling and grouping layers produce local sets of points and centroids, and the PointNet layer produces a feature vector formed by concatenating the local points. In some examples, multiscale grouping layers (denoted PointNetMsg) may be present, where groups of points are obtained using different radii centered at one centroid. In some examples, the neural network pipeline also includes multiple backbone layers. For example, two of the backbone layers may be PointNet set abstraction layers with multiscale grouping (e.g., PointNetMsg layers), following by two feature propagation layers (e.g., PointNetFP layers) and three set abstraction layers (e.g., PointNetSetAbstraction layers). The feature vector 140 output by the neural network circuitry 125 of the illustrated example includes a number of feature points, such as 1024 feature points or some other number, and is input to the object classification head circuitry 130 and the regression head circuitry 135. The object classification head circuitry 130 processes the feature vector 140 to output example object classification parameters 145 corresponding to the input candidate cluster 110. The regression head circuitry 135 processes the feature vector 140 to output example bounding box parameters 150 corresponding to the input candidate cluster 110.

In the illustrated example, the object classification head circuitry 130 implements an object classification head that is trained to classify detected objects based on a set of possible object classifications. Examples of such object classifications include, but are not limited to, automobile/car, truck, pedestrian, bicycle, etc. In some examples, the object classification head implemented by the object classification head circuitry 130 includes a neural network having three (3) fully connected layers with batch normalization and dropout, followed by a softmax operation for classification. In some examples, the object classification parameters 145 output by the object classification head circuitry 130 include respective probabilities that the input candidate cluster 110 corresponds to respective ones of the possible object classifications. In some examples, the object classification parameters 145 output by the object classification head circuitry 130 include an identified object classification for the input candidate cluster 110. For example, the identified object classification for the input candidate cluster 110 can correspond to the possible object classification with the highest probability. In some examples, the object classification parameters 145 output by the object classification head circuitry 130 include an indication that no object corresponding to set of possible object classifications was detected, such as when the highest object classification probability does not satisfy a threshold (e.g., such as 50%, 75%, or some other value).

In the illustrated example, the regression head circuitry 135 implements one or more regression heads trained to determine the bounding box parameters 150 for a detected object. In the illustrated example, the regression head circuitry 135 implements a number of regression heads corresponding to the number of possible object classifications, with each regression head corresponding to a respective possible object classification. As disclosed in further detail below, a given regression head is trained to output its own set of bounding box parameters 150 based on a ground truth bounding box associated with the given possible object classification corresponding to that regression head. In other words, a given regression head is trained to output a set of bounding box parameters 150 based on the assumption that the detected object has the given possible object classification corresponding to that regression head. In some examples, only one regression head may be present, which is trained using training clusters corresponding to all possible classifications and, thus, can be used for inference of any of the possible classifications. In some examples, a given regression head implemented by the regression head circuitry 135 includes a neural network having three (3) fully connected layers. In some examples, the set of bounding box parameters 150 output by a given regression head implemented by the regression head circuitry 135 includes regression values representative of differences between the ground-truth bounding box associated with that given regression head and a predicted, or proposed, bounding box output by that regression head based on the feature vector 140. In some examples, the regression head circuitry 135 may implement the bin-based bounding box regression head and loss function utilized by PointRCNN. Further details concerning implementation and operation of the regression head circuitry 135 are provided below.

The example object detector 100 of FIG. 1 also includes example training circuitry to train the object detection circuitry 120, which includes training the neural network(s) and/or other machine learning architecture(s) implemented by the neural network circuitry 125, the object classification head circuitry 130 and the regression head circuitry 135, based on training data. The training circuitry of the illustrated example includes example bounding box generation circuitry 155, example regression calculation circuitry 160, example loss function evaluation circuitry 165 and example neural network update circuitry 170. In the illustrated example, the bounding box generation circuitry 155 generates a proposal bounding box for a training cluster selected by the cluster selection circuitry 105 from a training 3D point cloud included in the training data. The particular object classification for the object represented by the training cluster is known from the training data. As such, in the illustrated example, the regression calculation circuitry 160 compares the proposal bounding box generated by the bounding box generation circuitry 155 to a ground-truth bounding box known based on the training data to represent that object classification. The regression calculation circuitry 160 further outputs example training regression values 175 representative of differences between the known ground-truth bounding box for the object classification and the proposal bounding box generated by the bounding box generation circuitry 155.

During training, the training cluster selected by the cluster selection circuitry 105 from the training 3D point cloud is also input to the object detection circuitry 120. As described above, the object classification head circuitry 130 outputs predicted object classification parameters 145, such as object classification probabilities, for the training cluster. As described above, the regression head circuitry 135 implements regression head(s) that output set(s) of bounding box parameters 150, which include regression values representative of differences between the ground-truth bounding box(es) and predicted bounding box(es) determined by the regression head(s). In the illustrated example of FIG. 1, the predicted object classification parameters 145 and the predicted bounding box parameters 150 output by the object classification head circuitry 130 and the regression head circuitry 135 during training are illustrated collectively as example predicted object classification and bounding box regression values 180.

In the illustrated example, the loss function evaluation circuitry 165 evaluates one or more loss functions based on the training regression values 175 output from the regression calculation circuitry 160 and the predicted object classification and bounding box regression values 180 output from the object detection circuitry 120. The loss function(s) can be any type and/or number of loss functions capable of quantifying error between the training regression values 175 and the predicted object classification and bounding box regression values 180. Example loss functions implemented by the loss function evaluation circuitry 165 are described in further detail below.

In the illustrated example, the neural network update circuitry 170 uses error value(s) output from the loss function evaluation circuitry 165 based on evaluation of the loss function(s) to update the neural network(s) and/or other machine learning algorithm(s) implemented by the object detection circuitry 120. For example, the neural network update circuitry 170 can implement one or more gradient descent and/or other algorithms, such as Adam gradient descent, RMSProp gradient descent, AdaGrad gradient descent, etc., that utilize the error value(s) output from the loss function evaluation circuitry 165 to update the layer weights and/or other parameters of the neural network layers implemented by the neural network circuitry 125, the object classification head circuitry 130 and/or the regression head circuitry 135 of the object detection circuitry 120.

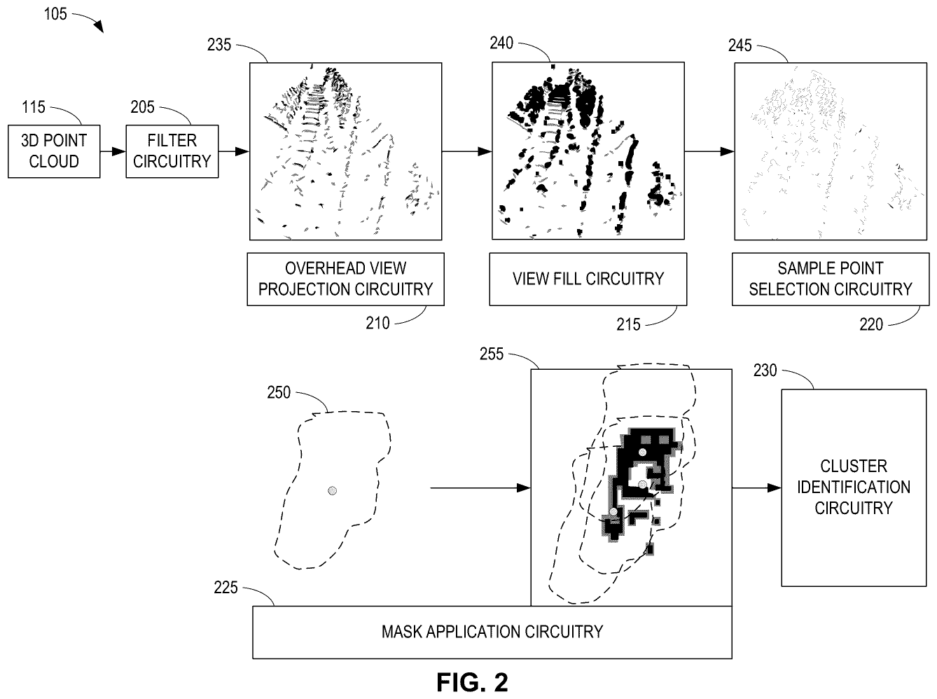

FIG. 2 is a block diagram of an example implementation of the cluster selection circuitry 105 included in the object detector 100 of FIG. 1. The cluster selection circuitry 105 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the cluster selection circuitry 105 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example cluster selection circuitry 105 of FIG. 2 includes example filter circuitry 205, example overhead view projection circuitry 210, example view fill circuitry 215, example sample point selection circuitry 220, example mask application circuitry 225 and example cluster identification circuitry 230. In the illustrated example of FIG. 2, the filter circuitry 205 performs one or more filter operations on an input 3D point cloud, such as the input 3D point cloud 115, to produce a filtered 3D point cloud. For example, the filter circuitry 205 can implement one or more filter operations to reduce or eliminate points from the 3D point cloud that correspond to reflections from the ground and/or sides of the scene. In an example implementation, the filter circuitry 205 (i) creates a histogram with 30 bins (or some other number of bins) representative of the heights (z-values) of the 3D points in the 3D point cloud, (ii) finds the bin, B, with the maximum number of points in the histogram, (iii) rejects points whose heights are in bin B or lower bins (e.g., with height less than that represented by bin B+1), and retains any 3D points in grid box(es) with at least 1 point remaining after step (iii).

The overhead view projection circuitry 210 of the illustrated example projects the filtered 3D point cloud (or the input 3D point cloud directly if the filter 205 is disabled or omitted) based on an overhead, top-down or birds-eye view projection to generate an example two-dimensional (2D) overhead view of the input 3D point cloud. For example, the resulting overhead view can be a 2D image or grid map created by projecting the points of the filtered 3D point cloud (or input 3D point cloud directly if the filter 205 is disabled or omitted) downward to the lowest (e.g., ground-level) horizontal plane of the 3D space corresponding to the input 3D point cloud. In some examples, the overhead view projection circuitry 210 reduces the dimensionality of the overhead view by using a grid map and clustering the projected points into cells, or patches, of the grid. For example, the overhead view projection circuitry 210 may determine that a cell (also referred to as a patch) of the grid map forming the overhead view is occupied and fill in that cell if the cell contains at least one projected point from the 3D point cloud. FIG. 2 illustrates an example overhead view 235 generated by the overhead view projection circuitry 210 for the input 3D point cloud 215.

The view fill circuitry 215 of the illustrated example fills in gaps in the overhead view generated by the overhead view projection circuitry 210. In some examples, the view fill circuitry 215 may apply a dilation kernel at different shifts over the overhead view. For a given shift, the view fill circuitry 215 may fill in a pixel of the overhead view corresponding to the center of the dilation kernel if at least one pixel covered by the dilation kernel is nonempty. For example, if the overhead view is formed by a grid map, the dilation kernel may be an N-by-N dilation kernel, such as a 9×9 dilation kernel, and the view fill circuitry 215 may fill in a center cell of the grid map if at least one cell covered the N-by-N dilation kernel is nonempty. FIG. 2 illustrates an example filled overhead view 240 generated by the view fill circuitry 215 for the input 3D point cloud 215.

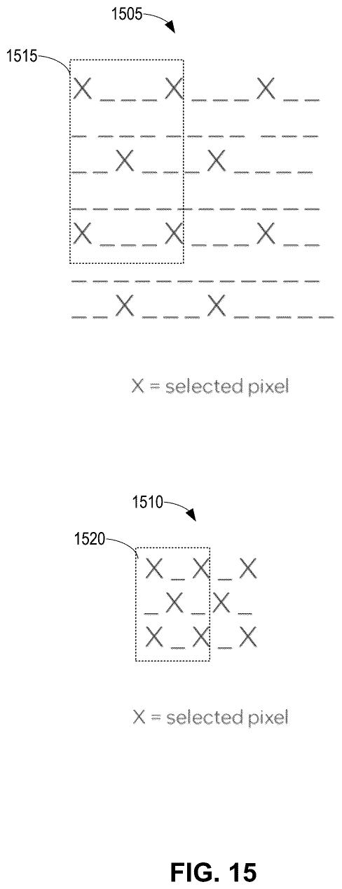

The sample point selection circuitry 220 of the illustrated example samples the filled overhead view output by the view fill circuitry 215 (or the overhead view output by the view projection circuitry 210 if the view fill circuitry 215 is disabled or omitted) to generate a sampled overhead view. For example, the sample point selection circuitry 220 samples the filled overhead view output by the view fill circuitry 215 (or the overhead view output by the view projection circuitry 210 if the view fill circuitry 215 is disabled or omitted) uniformly over the area of the overhead view, non-uniformly over the area of the overhead view (e.g., to avoid sample points near the edges of the view), etc. In some examples, if the filled overhead view (or the overhead view output by the view projection circuitry 210 if the view fill circuitry 215 is disabled or omitted) is represented by a grid map, the sample point selection circuitry 220 samples the grid map uniformly by selecting sample points using a regular pattern or based on a non-uniform pattern that avoids points near the edge of the overhead view. FIG. 15 illustrates example patterns 1505 and 1510 that can utilized by the sample point selection circuitry 220 for sample point selection. A first example uniform pattern 1505 illustrated in FIG. 15 includes an example 5×5 block of pixels 1515 centered at location (2,2) with the center sample and 4 corner sample being selected. In the uniform pattern 1505, the 5×5 block of selected pixels 1515 repeats at center locations (2,6), (2,10), (6,2), (6,6), etc. A second example uniform pattern 1510 illustrated in FIG. 15 includes an example 3×3 block of pixels 1520 centered at location (1,1) with the center sample and 4 corner samples being selected. In the uniform pattern 1510, the 3×3 block of selected pixels 1520 repeats repeated centered at (1,3), (3,1), (3,3), etc. FIG. 2 illustrates an example sampled overhead view 245 generated by the sample point selection circuitry 220 for the input 3D point cloud 215.

The mask application circuitry 225 of the illustrated example applies masks (and/or templates) to the filled overhead view output by the view fill circuitry 215 (or the overhead view output by the view projection circuitry 210 if the view fill circuitry 215 is disabled or omitted) at sample points of the sampled overhead view output by the sample point selection circuitry 220 to identify candidate clusters of points for use in object detection. In some examples, respective masks (and/or templates) are generated from training data and used to identify candidate clusters likely to represent respective possible object classifications. For example, a first mask (and/or a first template) may be generated from training data and used to identify candidate clusters representative of a first possible object classification (e.g., car or automobile), a second mask (and/or a first template) may be generated from the training data and used to identify candidate clusters representative of a second possible object classification (e.g., pedestrian), etc. In some examples, multiple masks (and/or templates) may be generated per class (e.g., multiple masks/templates for car, multiple masks/templates for pedestrian, etc.) In some examples, one or more representative masks (and/or templates) may be obtained by combining individual training masks determined for multiples classes (e.g., such that a representative mask may match objects having different classifications). FIG. 2 illustrates an example mask 250 for a first possible object classification, which is used by the mask application circuitry 225 to identify candidate clusters. Other example masks and templates, and examples of generating such masks and templates, are described in further detail below.

As depicted by an example insert 255 in the illustrated example, the mask application circuitry 225 applies the mask 250 to the filled overhead view output by the view fill circuitry 215 (or the overhead view output by the view projection circuitry 210 if the view fill circuitry 215 is disabled or omitted) at sample points of the sampled overhead view output by the sample point selection circuitry 220. For example, the insert 255 illustrates the mask application circuitry 225 applying the mask at three different sample points by centering the mask on each of the different sample points. For a given sample point, the mask application circuitry 225 includes the points of the filled overhead view (or the overhead view output by the view projection circuitry 210 if the view fill circuitry 215 is disabled or omitted) covered by the footprint of the mask 250 in a potential cluster for evaluation by the cluster identification circuitry 230. The mask application circuitry 225 repeats that operation for different sample points and for different masks (and/or templates) corresponding to different possible object classifications.

The cluster identification circuitry 230 of the illustrated example evaluates the potential clusters output by the mask application circuitry 225 to identify candidate clusters to be used for object detection (e.g., to be input to the object detection circuitry 120, the bounding box generation circuitry 155, etc.). In some examples, if the mask application circuitry 225 applies masks to identify the potential clusters, the cluster identification circuitry 230 determines a potential cluster is a candidate cluster if the number of points of the potential cluster covered by the mask used to select the cluster satisfies an occupancy target. In some examples, for mask-based selection, the occupancy target corresponds to an occupancy fraction threshold. For example, for a potential cluster identified based on a particular mask (e.g., the mask 250), the cluster identification circuitry 230 computes the occupancy fraction for the potential cluster to be the fraction of grid cells of the mask (e.g., the mask 250) that are occupied by points of the potential cluster. If the occupancy fraction satisfies (e.g., is greater than, is greater than or equal to, etc.) the occupancy fraction threshold (e.g., 0.7 or some other value), the cluster identification circuitry 230 determines the potential cluster is a candidate cluster.

In some examples, if the mask application circuitry 225 applies templates to identify the potential clusters, the cluster identification circuitry 230 determines a potential cluster is a candidate cluster if the number of points of the potential cluster covered by the template used to select the cluster satisfies an occupancy target. In some examples, for template-based selection, the occupancy target is based on a normalized correlation coefficient. For example, for a potential cluster identified based on a particular template, the cluster identification circuitry 230 computes the normalized correlation coefficient between the potential cluster and the template. If the normalized correlation coefficient satisfies (e.g., is greater than, is greater than or equal to, etc.) a threshold (e.g., 0.7 or some other value), the cluster identification circuitry 230 determines the potential cluster is a candidate cluster.

In the illustrated example, the cluster identification circuitry 230 represents a given candidate cluster as the set of points from the original input 3D point cloud that correspond with the points of the filled overhead view (or the overhead view output by the view projection circuitry 210 if the view fill circuitry 215 is disabled or omitted) included in the candidate cluster. After identifying a set of candidate clusters from the potential clusters output from the mask application circuitry 225, the cluster identification circuitry 230 implements a non-maximum suppression technique to select candidate clusters for downstream object detection processing (e.g., to be input to the object detection circuitry 120, etc.). For example, the cluster identification circuitry 230 sorts the set of candidate clusters in decreasing order of number of points, and to break ties, decreasing occupancy fraction or normalized correlation coefficient. In some examples, the cluster identification circuitry 230 discards candidate clusters that have at least a threshold number or fraction of points (e.g., 10% or some other value) in common with another candidate cluster higher in the sorted set. The cluster identification circuitry 230 then outputs the sorted set of candidate clusters (e.g., after discarding any candidate clusters satisfying the commonality threshold) in descending order for downstream processing until the sorted set of candidate clusters is empty.

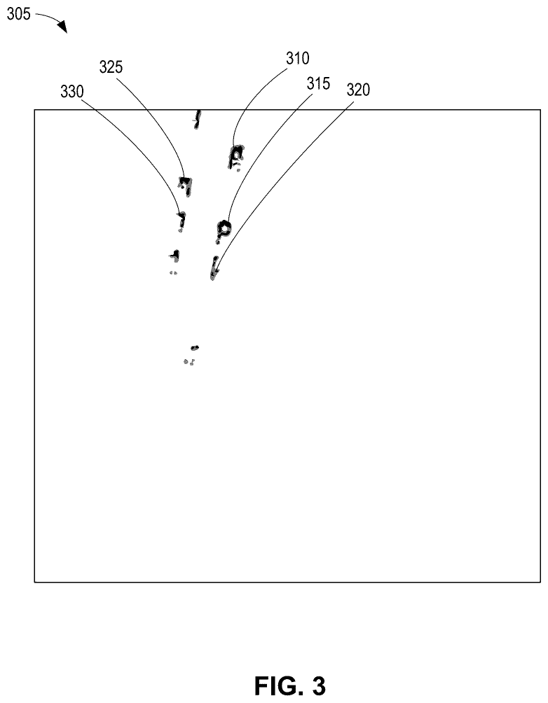

FIGS. 3-5 illustrate example masks and example templates utilized by the cluster selection circuitry 105 of FIGS. 1 and/or 2. For reference, FIG. 3 illustrates an example overhead view 305 determined from training data. The overhead view 305 contains example ground-truth objects 310-330. In the illustrated example, the ground truth objects 310-330 correspond to a car/automobile object classification.

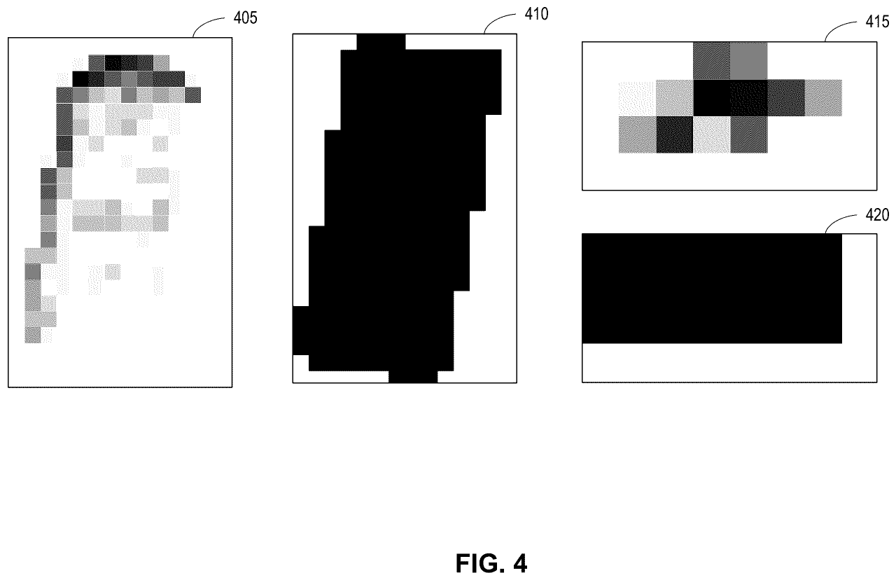

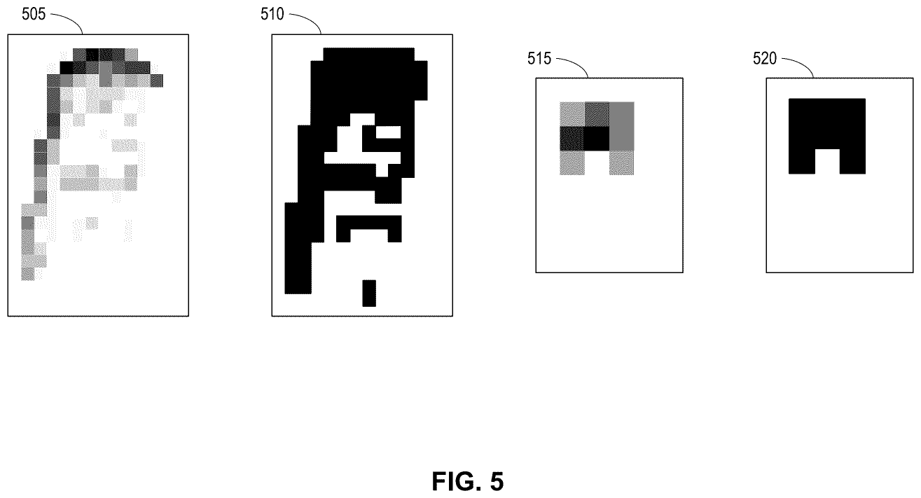

FIGS. 4-5 illustrate examples of masks and templates that can be generated from training data, such as the training data 305 of FIG. 3, for use by the cluster selection circuitry 105 of FIGS. 1 and/or 2. For example, FIG. 4 illustrates an example template 405 and a corresponding example mask 410 generated based on the example ground truth objects 310-330 included in the example training data 305 of FIG. 3. To generate the template 405 and the mask 410, a horizontal plane covering the 3D point cloud of the training data 305 is divided into a regular grid, and points from the 3D point cloud of the training data 305 are projected downward onto this grid. The number of points in each grid cell of the grid forms a grid map representing an overhead view of the 3D point cloud of the training data 305.

In the illustrated example, a template, such as the template 405, corresponds to a pattern that includes expected numbers of points in each grid cell for the object classification (e.g., car) represented by that template 405. In the illustrated example, a mask, such as the mask 410, corresponds to a binary mask that is set to true (e.g., logic-1) over the footprint of the template 405. FIG. 4 also illustrates an example template 415 and a corresponding example mask 420 corresponding to another possible object classification (e.g., pedestrian in the illustrated example).

FIG. 5 illustrates another example technique for generating masks from training data, such as the training data 305 of FIG. 3, for use by the cluster selection circuitry 105 of FIGS. 1 and/or 2. In the illustrated example of FIG. 5, an example mask 510 is generated from the template 405 by setting values of the mask 510 to true (e.g., logic-1) for grid cells of the template 405 that contain at least one point corresponding to the ground truth object. This is different from the mask 410, which has a value of true (e.g., logic-1) over the footprint of the template 405. FIG. 4 also illustrates an example template 515 and a corresponding example mask 520 generated using this example technique for another possible object classification (e.g., pedestrian in the illustrated example).

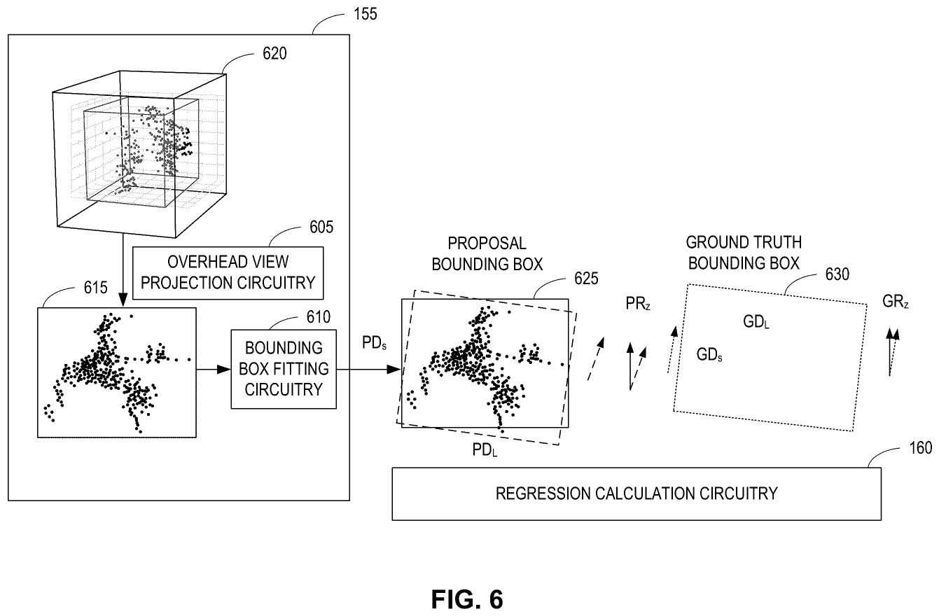

FIG. 6 is a block diagram of an example implementation of the bounding box generation circuitry 155 and the regression calculation circuitry 160 included in the object detector 100 of FIG. 1. The bounding box generation circuitry 155 and the regression calculation circuitry 160 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the bounding box generation circuitry 155 and the regression calculation circuitry 160 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The example bounding box generation circuitry 155 of FIG. 6 includes example overhead view projection circuitry 605 and example bounding box fitting circuitry 610. The overhead view projection circuitry 605 of the illustrated example accepts a 3D point cloud corresponding to a candidate cluster selected by the cluster selection circuitry 105. The overhead view projection circuitry 605 projects the candidate cluster's 3D point cloud based on an overhead, top-down or birds-eye view projection to generate an example 2D overhead view of the input 3D point cloud. For example, the resulting overhead view can be a 2D image or grid map created by projecting the points of the candidate cluster's 3D point cloud downward to the lowest (e.g., ground-level) horizontal plane of the 3D space corresponding to the 3D point cloud. In some examples, the overhead view projection circuitry 605 reduces the dimensionality of the overhead view by using a grid map and grouping the projected points into cells, or patches, of the grid. For example, the overhead view projection circuitry 605 may determine that a cell (also referred to as a patch) of the grid map forming the overhead view is occupied and fill in that cell if the cell contains at least one projected point from the candidate cluster's 3D point cloud. FIG. 6 illustrates an example overhead view 615 generated by the overhead view projection circuitry 605 for an example 3D point cloud 620 corresponding to an input candidate cluster provided by the cluster selection circuitry 105.

The bounding box fitting circuitry 610 of the illustrated example fits a proposal bounding box to the points of the input candidate cluster's 3D point cloud based on the overhead view output by the overhead view projection circuitry 605. The points of the overhead view correspond to projected points of the candidate cluster. As such, the bounding box fitting circuitry 610 can fit the proposal bounding box to the points of the input candidate cluster's 3D point cloud by fitting the proposal box in the horizontal dimension based on the overhead view output by the overhead view projection circuitry 605, and fitting the proposal bounding box in the vertical dimension based on the height of the input candidate cluster's 3D point cloud 620. In some examples, for a given candidate cluster selected by cluster selection circuitry 105, the bounding box fitting circuitry 610 determines a corresponding 3D rectangular bounding box, referred to as a cuboid, to represent the location, size and orientation of the candidate cluster. For example, the bounding box fitting circuitry 610 can implement a minimum area rectangle algorithm to fit a 2D rectangular bounding box to the overhead view corresponding to the input candidate cluster's 3D point cloud. The bounding box fitting circuitry 610 also finds minimum and maximum vertical coordinates of the points in the candidate cluster's 3D point cloud. The bounding box fitting circuitry 610 then creates the cuboid (e.g., 3D rectangular bounding box) as a combination of the 2D rectangular bounding box in the horizontal plane, and the minimum and maximum vertical coordinates in the vertical plane. As illustrated in FIG. 6, a cuboid has shorter and longer horizontal dimensions denoted as S and L, respectively, and a vertical height denoted as Z. The bounding box fitting circuitry 610 also determines an angle between the shorter horizontal dimension (e.g., the shorter side of the 2D rectangular bounding box) and the forward direction, which is denoted as PRz and represents an orientation of the proposal bounding box. FIG. 6 illustrates an example proposal bounding box 625 generated by the bounding box fitting circuitry 610 for the example input candidate cluster's 3D point cloud 620. During inference processing, the input candidate cluster's 3D point cloud 620 and, in some examples, the proposal bounding box 625 generated from the input candidate cluster's 3D point cloud 620 is provided to the object detection circuitry for object detection (e.g., for infer/estimate classification and regression parameters, etc.).

During training, the overhead view projection circuitry 605 and the bounding box fitting circuitry 610 operate similarly to determine a 2D oriented rectangular bounding box for each ground truth cluster represented in the input training data. Furthermore, during training, the bounding box fitting circuitry 610 compares each input candidate cluster to the ground truth clusters present in the source point cloud to check for matches. In some examples, the bounding box fitting circuitry 610 identifies a match if the point-IoU (intersection-over-union) of the 2D bounding boxes is greater than a threshold, such as 0.5 or some other value. In some examples, the bounding box fitting circuitry 610 determines the point-IoU as a fraction corresponding to the number of common points in the two clusters divided by the number of points in the union of the two clusters. In some examples, bounding box fitting circuitry 610 may use a conventional IoU as the match metric, where the conventional IoU is determined as a fraction corresponding to the intersection area of bounding boxes divided by the union area of bounding boxes. Matching candidate cluster and ground truth cluster pairs are used by the regression calculation circuitry 160 to generate regression parameters to train the object detection circuitry 120 of the object detector 100.

For example, during training, the regression calculation circuitry 160 of the illustrated example compares the proposal bounding box generated by the bounding box fitting circuitry 610 to the ground-truth bounding box for the matching ground truth object cluster to generate training regression parameters to train the object detection circuitry 120 of the object detector 100. In some examples, the regression calculation circuitry 160 represents the proposal bounding box using (i) the midpoint coordinate of the proposal bounding box, (ii) the length, width and height of the proposal bounding box (with the length and width corresponding to the longest and shortest horizontal dimensions of the proposal bounding box, respectively, and the height corresponding to the vertical dimension of the proposal bounding box), and (iii) the angle, denoted as PRz, between the width (shortest horizontal dimension) of the proposal bounding box and the forward direction. Similarly, in some examples, the regression calculation circuitry 160 represents the ground truth bounding box using (i) the midpoint coordinate of the ground truth bounding box, (ii) the length, width and height of the ground truth bounding box (with the length and width corresponding to the longest and shortest horizontal dimensions of the ground truth bounding box, respectively, and the height corresponding to the vertical dimension of the ground truth bounding box), and (iii) the angle, denoted as GRz, between the width (shortest horizontal dimension) of the ground truth bounding box and the forward direction. FIG. 6 illustrates an example ground truth bounding box 630 corresponding to the example ground truth object (or example ground truth object classification) represented by the example training 3D point cloud 620.

In the illustrated example, the regression calculation circuitry 160 utilizes the preceding parameters of the proposal bounding box and the ground truth bounding box to compute the training regression parameters. For example, let the following notation represent the parameters of the proposal bounding box and the ground truth bounding box:
(Gx, Gy, Gz) represents the x, y and z coordinates of the ground truth bounding box midpoint, where x corresponds to the forward direction in the horizontal plane, y corresponds to the perpendicular direction in the horizontal plane, and z corresponds to the vertical plane;
(Px, Py, Pz) represents the corresponding x, y and z coordinates of the proposal bounding box midpoint;
(GD_{S}, GD_{L}, GD_{z}) represents the ground truth bounding box dimensions, where S represents the shortest horizontal dimension, L represents the longest horizontal dimension, and Z represents the vertical dimension;
(PD_{S}, PD_{L}, PD_{z}) represents the corresponding proposal bounding box dimensions;
GRz represents the angle between the shortest horizontal dimension of the ground truth bounding box (e.g., the width) and the forward direction (e.g., x); and
PRz represents the angle between the shortest horizontal dimension of the proposal bounding box (e.g., the width) and the forward direction (e.g., x).

Based on the preceding notation, the regression calculation circuitry 160 of the illustrated example generates seven (7) example training regression parameters given by Equations 1-7, which are:

$$tx = \frac{{G}_{x} - {P}_{x}}{P {D}_{L}} \qquad Equation 1$$

$$ty = \frac{{G}_{y} - {P}_{y}}{P {D}_{L}} \qquad Equation 2$$

$$tz = \frac{{G}_{z} - {P}_{z}}{P {D}_{z}} \qquad Equation 3$$

$$tw = ln \frac{{GD}_{w}}{P {D}_{S}} \qquad Equation 4$$

$$tl = ln \frac{G {D}_{l}}{P {D}_{L}} \qquad Equation 5$$

$$th = ln \frac{G {D}_{z}}{P {D}_{z}} \qquad Equation 6$$

$$a = G {R}_{z} - P {R}_{z} \qquad Equation 7$$

In Equations 1-3, tx, ty and tz represent bounding box midpoint regression differences in the x, y and z directions, respectively. In Equations 4-6, tw, tl and th represent bounding box size regression differences in the width, length and height dimensions respectively. In Equation 7, a represents a bounding box orientation regression difference.

Referring to FIG. 1, during training, the neural network circuitry 125 processes the 3D point cloud corresponding to the ground-truth object to generate the feature vector 140. The object classification head circuitry 130 processes the feature vector 140 to output the object classification parameters 145 include respective classification probabilities for the different possible object classifications. The regression head circuitry 135 implements regression heads corresponding respectively to the different possible object classifications. The regression heads implemented by the regression head circuitry 135 process the feature vector 140 to determine respective sets of bounding box parameters 150 that include respective sets of inference regression parameters ( [symbol] â) corresponding respective to the training regression parameters (tx, ty, tz, tw, tl, th, a) of Equations 1-7. However, each regression head determines its respective set of inference regression parameters ( [symbol] â) using the feature vector and the respective possible object classification corresponding to the [symbol] regression head.

Again referring to FIG. 1, in some examples, the loss function evaluation circuitry 165 implements one or more loss functions based on the classification probabilities included in the object classification parameters 145 output by the object classification head circuitry 130, the ground truth object classification corresponding to the input training cluster (e.g., the training 3D point cloud), the training regression parameters (tx, ty, tz, tw, tl, th, a), and the inference regression parameters ( [symbol] â) included in respective sets of bounding box [symbol] parameters 150 output by the regression heads implemented by the regression head circuitry 135. For example, the loss function evaluation circuitry 165 can implement an example classifier loss function, an example regression loss function, and example angle loss function, and an example total loss function based on Equations 8-11, which are:

$$Classifier Loss : C = Negative Log Likelihood ( ground truth class , prediction probablities ) \qquad Equation 10$$

$$Regression Loss : R = Smooth - L 1 Loss ( ( tx - ) + ( ty - ) + ( tz - ) + ( tw - ) + ( tl - ) + ( th - ) ) \qquad Equation 11$$

$$Angle Loss : A = Smooth - L 1 Loss ( sin ( a - \hat{a} ) ) \qquad Equation 12$$

$$Total Loss = C + K * ( R + A ) \qquad Equation 11$$

In Equation 11, K is a constant, such as the value 5 or some other value. In some examples, when computing the regression loss function, R, of Equation 9 and the angle loss function, A, of Equation 10, the loss function evaluation circuitry 165 limits evaluation to the inference regression parameters ( [symbol] â) output by the regression head corresponding to the ground truth object classification.

Again referring to FIG. 1, in some examples, the neural network update circuitry 170 uses the total loss error output by the loss function evaluation circuitry 165 based on Equation 11 to update the layer weights and/or other parameters of the neural network layers implemented by the neural network circuitry 125, the object classification head circuitry 130 and/or the regression head circuitry 135 of the object detection circuitry 120. In some examples, when updating the layer weights and/or other parameters of the neural network layers implemented by the regression head circuitry 135, the neural network update circuitry 170 limits updating to those layer weights and/or other parameters corresponding to the particular regression head associated with the ground truth object classification.

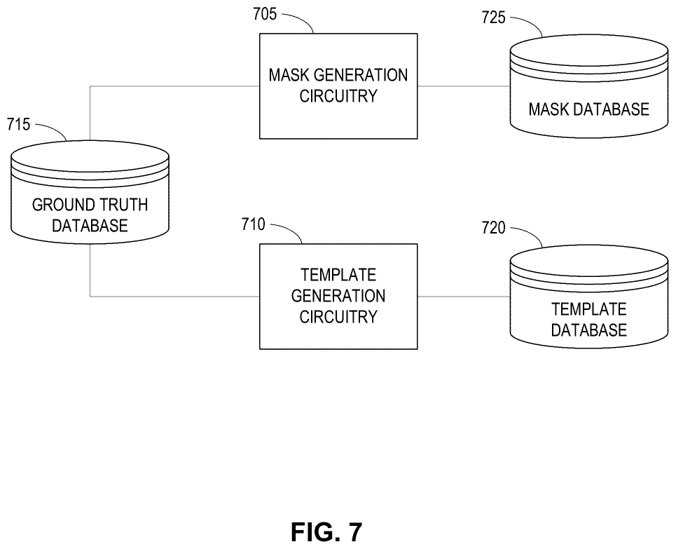

FIG. 7 is a block diagram of example mask generation circuitry 705 and example template generation circuitry 710 to generate example masks and/or example templates, such as the example masks and templates of FIGS. 3-5, for use by the object detector 100 of FIG. 1. The mask generation circuitry 705 and/or the template generation circuitry 710 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the mask generation circuitry 705 and/or the template generation circuitry 710 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

In some examples, the mask generation circuitry 705 and the template generation circuitry 710 of FIG. 7 are implemented as part of the training circuitry of the object detector 100 of FIG. 1. In some examples, the training circuitry of the object detector 100 may include both the mask generation circuitry 705 and the template generation circuitry 710. In some examples, the training circuitry of the object detector 100 may include the mask generation circuitry 705 or the template generation circuitry 710, but not both.

In the example of FIG. 7, the mask generation circuitry 705 and the template generation circuitry 710 access training 3D point clouds from ground truth training data in an example ground truth database 715. The mask generation circuitry 705 and the template generation circuitry 710 project the training 3D point clouds onto overhead views, such as the overhead grid maps described above. The mask generation circuitry 705 and the template generation circuitry 710 identify patterns representative of different possible object classes from the overhead grid maps. For example, the patterns identified by the template generation circuitry 710 are templates represented by an array [xᵢⱼ] of size R*C, where each xᵢⱼ is a count of points in the grid box. The templates are stored by the template generation circuitry 710 in an example template database 720. As another example, the patterns identified by the mask generation circuitry 705 are binary masks derived from the templates such that has the mask has a value of true (e.g., logic-1) if the count of points is nonzero, and false (logic-0) otherwise. The masks are stored by the mask generation circuitry 705 in an example mask database 725.

An example mask generation algorithm implemented by the mask generation circuitry 705 is described below. The mask generation circuitry 705 utilizes the mask generation algorithm to generate representative masks for the respective different possible object classes. As described below, the mask generation algorithm generates one or more representative masks for a given possible object class as a union of a group of individual masks obtained from training 3D point clouds corresponding to different instances of ground truth object belonging to that given possible object class. As such, masks for each possible object class in the training data set (e.g., car, pedestrian, etc.) are generated by merging individual masks corresponding to that possible object class. A similar template generation algorithm can be implemented by the template generation circuitry 710 to generate templates instead of masks, with the difference being the use of a normalized correlation coefficient (NCC) to measure similarity of templates instead of an occupancy fraction used to measure similarity of masks.

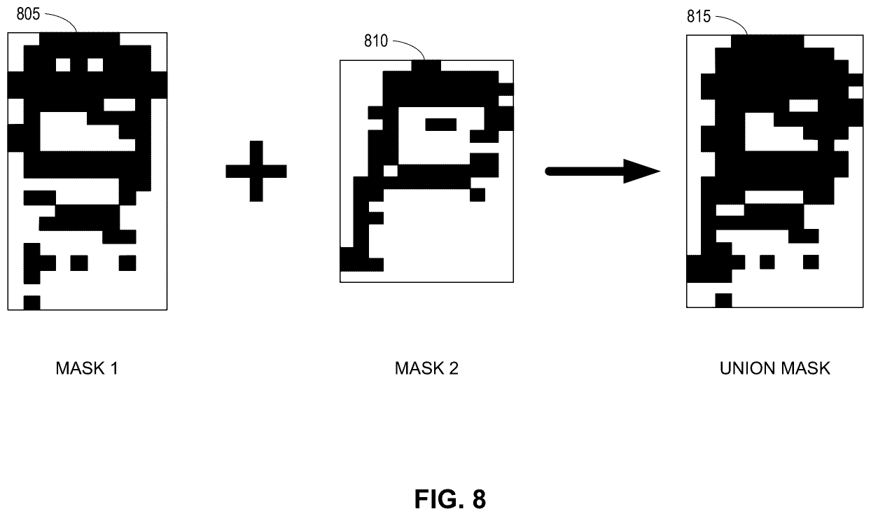

FIG. 8 illustrates an example representative mask 805 generated by the mask generation circuitry 705 for a given possible object class using the mask generation algorithm described below. In the illustrated example, the representative mask 805 is generated as a union of a first example mask 810 and a second example mask 815 determined for different instance of objects belonging to the given possible object class.

Returning to FIG. 7, the example mask generation algorithm implemented by the mask generation circuitry 705 is described based on the following terminology:

Set of masks S: This term refers to a set of masks {Mi} obtained from training data, with the set having number of elements K(S).

Union of masks: This term refers to a mask obtained from a set of masks {Mi} as follows:
(i) find the maximum of each dimension (rows, columns) over the set of masks;
(ii) create a new binary mask M with these maximum dimensions and with all pixels set to false;
(iii) center each source mask Mi in this mask M; and
(iv) at each overlapping pixel in the two masks, set the corresponding pixel in M to true if the overlapping pixel in Mi is true.

Representative mask R(S) of a set of masks S: This term refers to a union of masks of the masks in set S.

Occupancy fraction of mask Mi relative to representative mask R(S): This term refers to an occupancy fraction determined as follows:
(i) center mask Mi in R(S);
(ii) find an intersection mask that is the intersection of the two masks or, in other words, the intersection mask is a mask the same size as R(S) in which a pixel is true only if the overlapping pixels in both the masks are true;
(iii) find the number of true pixels in the intersection mask and in R(S); and
(iv) the occupancy fraction f(i) is the ratio (number of true pixels in the intersection mask)/(number of true pixels in R(S)).

Minimum occupancy fraction, f(S), of Set S: This term refers to the minimum of the occupancy fractions of all masks in the set S, which can be represented mathematically as min{f(i)}.

Occupancy fraction thresholds T(K): This term refers to a set of threshold values that depend on the size K (number of masks) of a set of masks S. A set of masks is valid if f(S)>T(K(S)).

Given the foregoing terminology, example pseudocode for an example mask generation algorithm implemented by the mask generation circuitry 705 is provided in Table 1.

TABLE 1

| (i) | Create set list S with initial Sets Sᵢ = {Mᵢ}, i = 1 ... N, each containing one binary mask | |
|---|---|---|
| | Mᵢ | |
| (ii) | Valid_Pairs_List = { } | |
| (iii) | For each pair of Sets Sᵢ, Sⱼ : | |
| | a. | Min_Occ_Frac, is_Valid = Test_Union(Sᵢ, Sⱼ) |
| | b. | If is_Valid: |
| | | Add(Sᵢ, Sⱼ, Min_Occ_Frac) to Valid_Pairs_List |
| (iv) | While Valid_Pairs_List is Not Empty: | |
| | a. | (Sₚ, S_{q}; f) ← Pair with Maximum Min_Occ_Frac from Valid_Pairs_List |
| | b. | Remove (Sₚ, S_{q}; f) from Valid_Pairs_List |
| | c. | Remove Sₚ , S_{q} from set list S |
| | d. | Add Sₜ to set list S |
| | e. | New_Pairs_List = [ ] |
| | f. | For each pair (Sₘ, Sₚ; f) in Valid_Pairs_List that contains Sₚ: |

| | |
|---|---|
| i. | Min_Occ_Frac, is_Valid = Test_Union(Sₘ, Sₜ) |
| ii. | If is_Valid: |
| | Add(Sₘ, Min_Occ_Frac) to New_Pairs_List |
| iii. | Remove (Sₘ, Sₚ ; f) from Valid_Pairs_List |

| | |
|---|---|
| g. | For each pair (Sₘ, S_{q} ; f) in Valid_Pairs_List that contains S_{q}: |

| | |
|---|---|
| i. | Min_Occ_Frac, is_Valid = Test_Union(Sₘ , Sₜ) |
| ii. | If is_Valid: |
| | Add(Sₘ , Min_Occ_Frac) to New_Pairs_List |
| iii. | Remove (Sₘ, S_{q} ; f) from Valid_Pairs_List |

| | |
|---|---|
| h. | Remove duplicates in New_Pairs_List |
| i. | For each pair (Sₘ, Min_Occ_Frac) in New_Pairs_List: |

Add(Sₜ, Sₘ , Min_Occ_Frac) to Valid_Pairs_List

| | |
|---|---|
| (v) | For each remaining Set Sᵢ : |

Find Representative Mask R(Sᵢ)

The example pseudocode of Table 1 employs an example helper function, Test_Union( ), provided in Table 2.

TABLE 2
Test_Union(Sᵢ, Sⱼ):

| | |
|---|---|
| i. | Create the union of sets Sₖ = Sᵢ ∪ Sⱼ |
| ii. | Find Representative Mask R(Sₖ) of Sₖ |
| iii. | Find Minimum Occupancy Fraction of Set Sₖ f(Sₖ) |
| iv. | If Minimum Occupancy Fraction f(Sₖ) > Threshold T(K(S)): |
| | Return f (Sₖ), True |
| v. | Else: Return 0, False |

An explanation of the example mask generation algorithm corresponding to the example pseudocode of Table 1 is as follows. The algorithm greedily merges masks that are similar (and, thus, will be represented closely by their union). In operations (i)-(iii) of Table 1, each mask is used to create a 1-member set. Pairs of sets are tested to check if the union of masks represents each of the elements in the set closely enough (as evaluated by the Test_Union helper function of Table 2). Pairs that pass the test are added into the Valid_Pairs_List as a tuple (Sᵢ, Sⱼ, f), where f is the Minimum Occupancy Fraction obtained by the Test_Union helper function of Table 2

At each iteration of operation (iv) in Table 1, the best tuple (Sₚ, S_{q}, f) from the Valid_Pairs_List is removed. The union set Sₜ=Sₚ U S_{q} is used to replace Sₚ and S_{q} in the set list S, and is also used in any tuples in the Valid_Pairs_List that Sₚ and S_{q} are involved in. The new tuples are tested against the thresholds appropriate for the size of the merged set, and kept if they meet the threshold.

The example pseudocode of Table 1 and Table 2 results in sets of matching masks, each with a representative mask that is used for candidate cluster selection, as described above.

In the example pseudocode of Table 1 and Table 2, the minimum occupancy fraction of each candidate set S is tested against a threshold, T(K), that depends on the size of the set K(S). In some examples, T(K) decreases sublinearly with K to allow some spread in the union mask as K increases. For example, the threshold can be set according to Equation 12, which is:

$$T ( K ) = C 1 + {Ce}^{a K} \qquad Equation 12$$

In Equation 12, C1, C and a are set to meet one or more target conditions. For example, C and a can be set such that T(2)=0.7 and T(200)=0.5. Furthermore, C1 can be set to the minimum value for large K (e.g., C1=0.3).

In some examples, the pseudocode of Table 1 and Table 2 can form the basis of an example template generation algorithm implemented by the template generation circuitry 710. However, for template generation, template similarity is compared using a normalized correlation coefficient instead of the occupancy fraction. For example, calculation of the occupancy fraction can be replaced in the pseudocode of Table 1 and Table 2 with the following example calculation of the normalized correlation coefficient.

To begin, each template pattern consists of an array [xᵢⱼ] of size R*C, where each xᵢⱼ is a count of points in the grid box.

Let T be the number of boxes that are True in the binary mask.

$$Then the mean , μ , is given by μ = \sum {x}_{ij} / T .$$

$$Let {y}_{ij} = {x}_{ij} - μ and {z}_{ij} = \frac{{y}_{ij}}{\sqrt{\sum {y}_{kl}^{2}}} .$$

Each normalized pattern [zᵢⱼ] has 0-mean and unit norm.

Finally, to obtain the normalized correlation coefficient between two normalized templates:

(i) overlap the templates so their centers match and extend as needed, filling with 0; and

(ii) compute the normalized correlation coefficient, cᵢⱼ, as cᵢⱼ=<zᵢ, zⱼ> where <,> represents the dot product.

Also, instead of a union of masks, the representative template of a set of templates is obtained by finding the mean of the unnormalized templates, and then normalizing.

In some examples, an initial K-means clustering can also be done to group masks of similar dimensions, and the algorithms described above can be performed on each group.

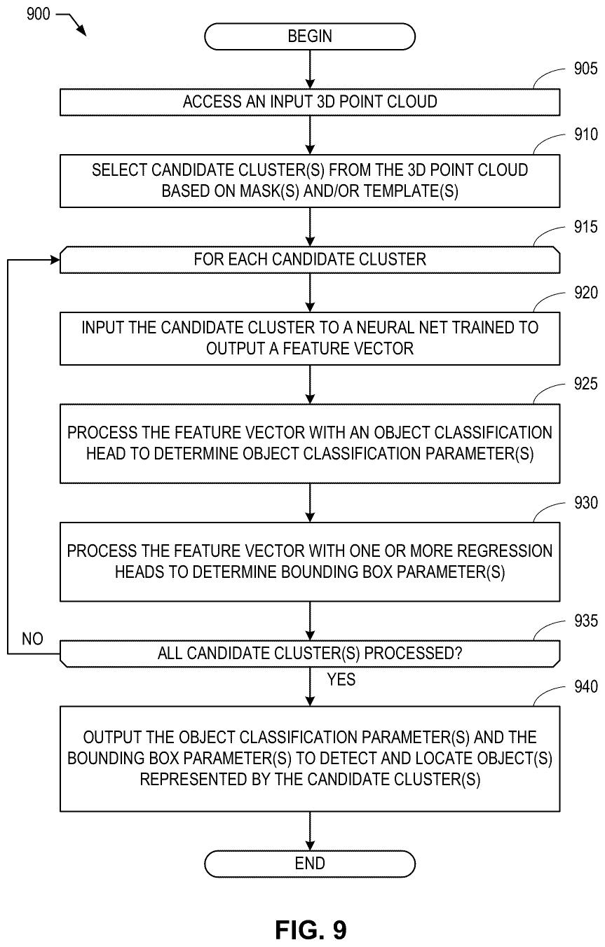

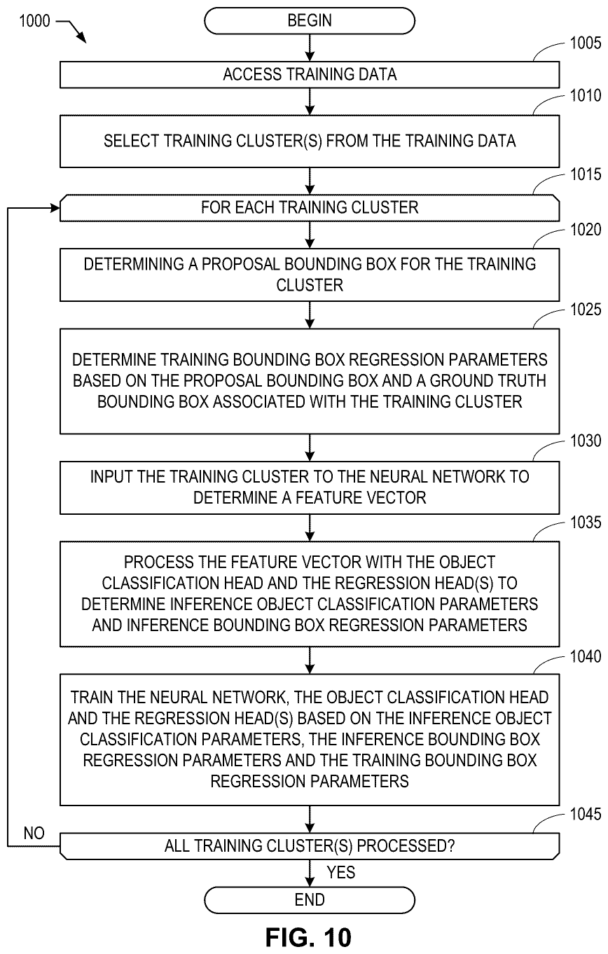

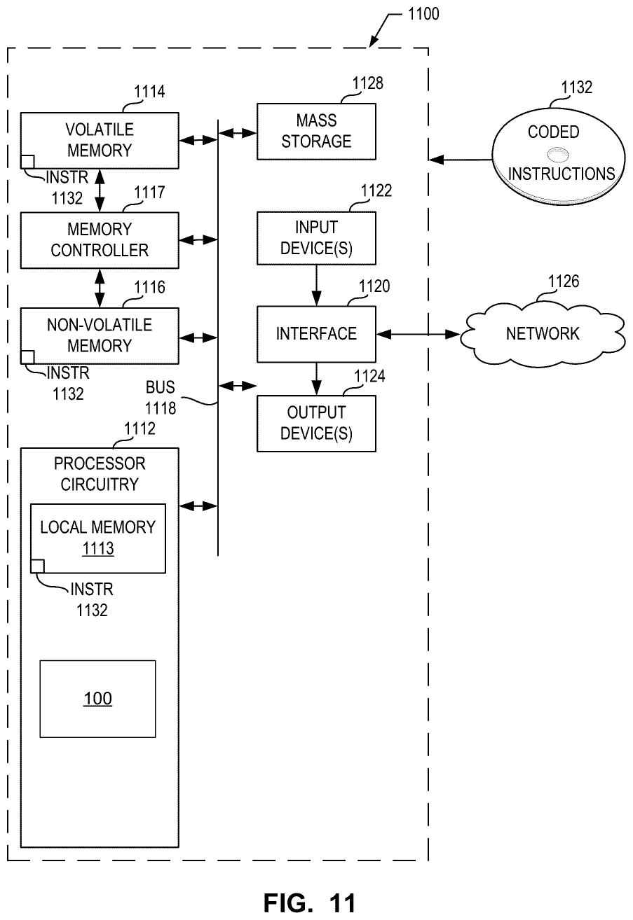

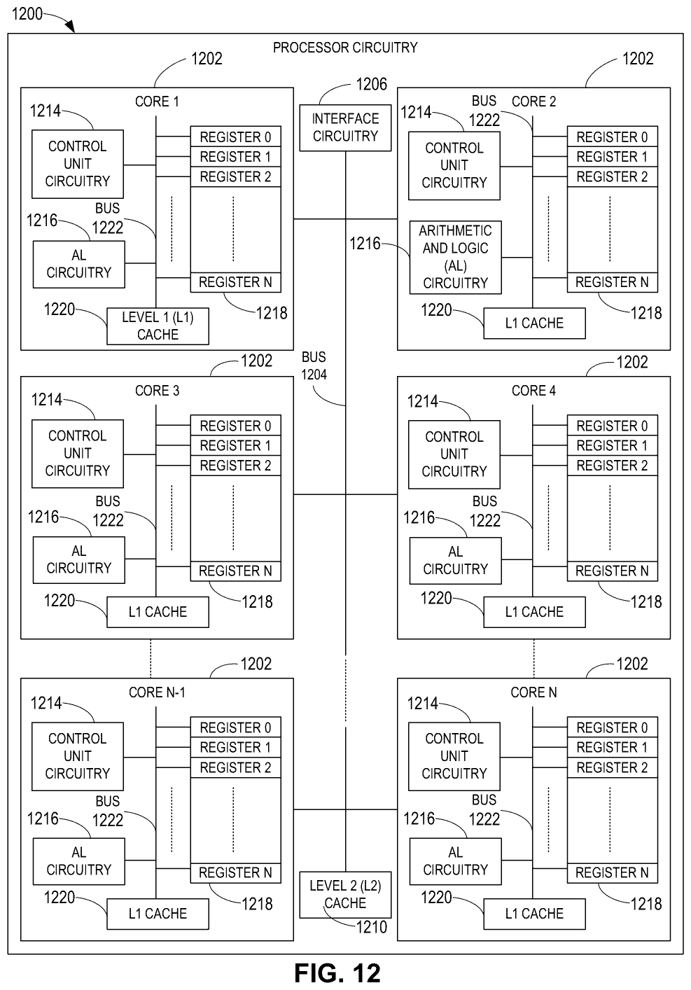

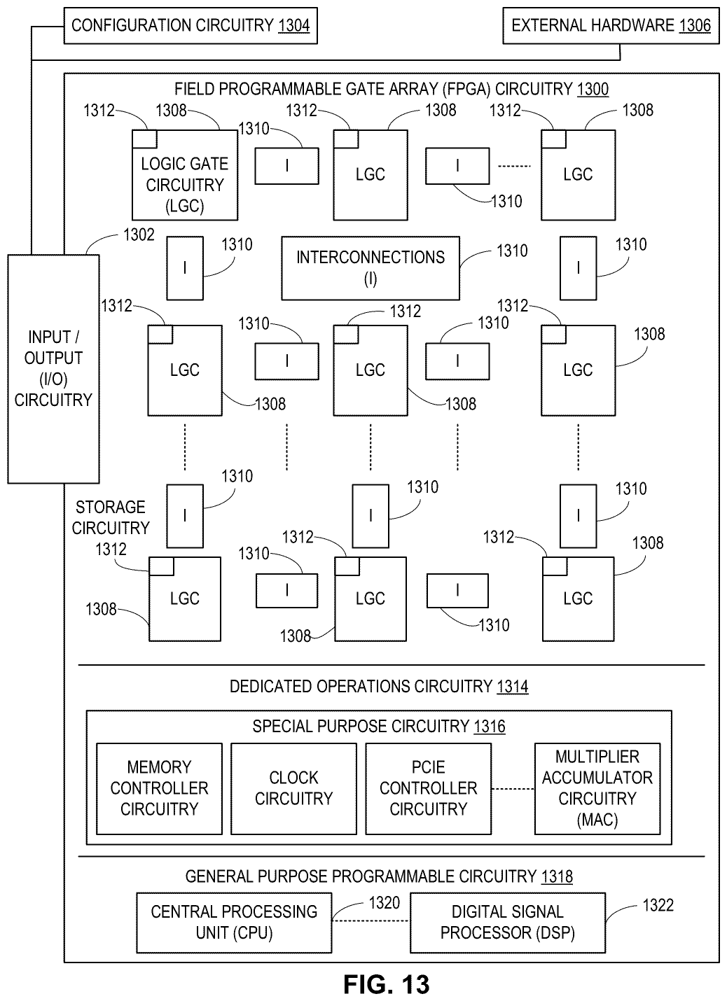

In some examples, the object detector 100 includes means for selecting clusters. For example, the means for selecting clusters may be implemented by the cluster selection circuitry 105. In some examples, the cluster selection circuitry 105 may be instantiated by programmable circuitry such as the example programmable circuitry 1112 of FIG. 11. For instance, the cluster selection circuitry 105 may be instantiated by the example microprocessor 1200 of FIG. 12 executing machine executable instructions such as those implemented by at least blocks 910 of FIG. 9 and 1010 of FIG. 10. In some examples, the cluster selection circuitry 105 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the cluster selection circuitry 105 may be instantiated by any other combination of hardware, software, and/or firmware. For example, the cluster selection circuitry 105 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detector 100 includes means for neural network processing. For example, the means for neural network processing may be implemented by the neural network circuitry 125. In some examples, the neural network circuitry 125 may be instantiated by programmable circuitry such as the example programmable circuitry 1112 of FIG. 11. For instance, the neural network circuitry 125 may be instantiated by the example microprocessor 1200 of FIG. 12 executing machine executable instructions such as those implemented by at least blocks 920 of FIG. 9 and 1030 of FIG. 10. In some examples, the neural network circuitry 125 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the neural network circuitry 125 may be instantiated by any other combination of hardware, software, and/or firmware. For example, the neural network circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detector 100 includes means for implementing an object classification head. For example, the means for implementing an object classification head may be implemented by the object classification head circuitry 130. In some examples, the object classification head circuitry 130 may be instantiated by programmable circuitry such as the example programmable circuitry 1112 of FIG. 11. For instance, the object classification head circuitry 130 may be instantiated by the example microprocessor 1200 of FIG. 12 executing machine executable instructions such as those implemented by at least blocks 925 of FIG. 9 and 1035 of FIG. 10. In some examples, the object classification head circuitry 130 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the object classification head circuitry 130 may be instantiated by any other combination of hardware, software, and/or firmware. For example, the object classification head circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detector 100 includes means for implementing one or more regression heads. For example, the means for implementing one or more regression heads may be implemented by the regression head circuitry 135. In some examples, the regression head circuitry 135 may be instantiated by programmable circuitry such as the example programmable circuitry 1112 of FIG. 11. For instance, the regression head circuitry 135 may be instantiated by the example microprocessor 1200 of FIG. 12 executing machine executable instructions such as those implemented by at least blocks 930 of FIG. 9 and 1035 of FIG. 10. In some examples, the regression head circuitry 135 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the regression head circuitry 135 may be instantiated by any other combination of hardware, software, and/or firmware. For example, the regression head circuitry 135 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detector 100 includes means for generating bounding boxes. For example, the means for implementing bounding boxes may be implemented by the bounding box generation circuitry 155. In some examples, the bounding box generation circuitry 155 may be instantiated by programmable circuitry such as the example programmable circuitry 1112 of FIG. 11. For instance, the bounding box generation circuitry 155 may be instantiated by the example microprocessor 1200 of FIG. 12 executing machine executable instructions such as those implemented by at least block 1020 of FIG. 10. In some examples, the bounding box generation circuitry 155 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the bounding box generation circuitry 155 may be instantiated by any other combination of hardware, software, and/or firmware. For example, the bounding box generation circuitry 155 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detector 100 includes means for calculating regression values. For example, the means for calculating regression values may be implemented by the regression calculation circuitry 160. In some examples, the regression calculation circuitry 160 may be instantiated by programmable circuitry such as the example programmable circuitry 1112 of FIG. 11. For instance, the regression calculation circuitry 160 may be instantiated by the example microprocessor 1200 of FIG. 12 executing machine executable instructions such as those implemented by at least block 1025 of FIG. 10. In some examples, the regression calculation circuitry 160 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the regression calculation circuitry 160 may be instantiated by any other combination of hardware, software, and/or firmware. For example, the regression calculation circuitry 160 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detector 100 includes means for evaluating loss functions. For example, the means for evaluating loss functions may be implemented by the loss function evaluation circuitry 165. In some examples, the loss function evaluation circuitry 165 may be instantiated by programmable circuitry such as the example programmable circuitry 1112 of FIG. 11. For instance, the loss function evaluation circuitry 165 may be instantiated by the example microprocessor 1200 of FIG. 12 executing machine executable instructions such as those implemented by at least block 1040 of FIG. 10. In some examples, the loss function evaluation circuitry 165 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the loss function evaluation circuitry 165 may be instantiated by any other combination of hardware, software, and/or firmware. For example, the loss function evaluation circuitry 165 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detector 100 includes means for updating neural networks. For example, the means for updating neural networks may be implemented by the neural network update circuitry 170. In some examples, the neural network update circuitry 170 may be instantiated by programmable circuitry such as the example programmable circuitry 1112 of FIG. 11. For instance, the neural network update circuitry 170 may be instantiated by the example microprocessor 1200 of FIG. 12 executing machine executable instructions such as those implemented by at least block 1040 of FIG. 10. In some examples, the neural network update circuitry 170 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the neural network update circuitry 170 may be instantiated by any other combination of hardware, software, and/or firmware. For example, the neural network update circuitry 170 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the object detector 100 is illustrated in FIGS. 1-8, one or more of the elements, processes, and/or devices illustrated in FIGS. 1-8 may be combined, divided, re-arranged, omitted, eliminated, and/or implemented in any other way. Further, the example cluster selection circuitry 105, the example object detection circuitry 120, the example neural network circuitry 125, the example object classification head circuitry 130, the example regression head circuitry 135, the example bounding box generation circuitry 155, the example regression calculation circuitry 160, the example loss function evaluation circuitry 165, the example neural network update circuitry 170, the example filter circuitry 205, the example overhead view projection circuitry 210, the example view fill circuitry 215, the example sample point selection circuitry 220, the example mask application circuitry 225, the example cluster identification circuitry 230, the example overhead view projection circuitry 605, the example bounding box fitting circuitry 610, the example mask generation circuitry 705, the example template generation circuitry 710 and/or, more generally, the example object detector 100 may be implemented by hardware alone or by hardware in combination with software and/or firmware. Thus, for example, any of the example cluster selection circuitry 105, the example object detection circuitry 120, the example neural network circuitry 125, the example object classification head circuitry 130, the example regression head circuitry 135, the example bounding box generation circuitry 155, the example regression calculation circuitry 160, the example loss function evaluation circuitry 165, the example neural network update circuitry 170, the example filter circuitry 205, the example overhead view projection circuitry 210, the example view fill circuitry 215, the example sample point selection circuitry 220, the example mask application circuitry 225, the example cluster identification circuitry 230, the example overhead view projection circuitry 605, the example bounding box fitting circuitry 610, the example mask generation circuitry 705, the example template generation circuitry 710 and/or, more generally, the example object detector 100 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example object detector 100 may include one or more elements, processes, and/or devices in addition to, or instead of, those illustrated in FIGS. 1-8, and/or may include more than one of any or all of the illustrated elements, processes and devices.

Flowchart(s) representative of example machine readable instructions, which may be executed by programmable circuitry to implement and/or instantiate the object detector 100 and/or representative of example operations which may be performed by programmable circuitry to implement and/or instantiate the object detector 100, are shown in FIGS. 9 and/or 10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9 and/or 10, many other methods of implementing the example object detector 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9 and/or 10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by programmable circuitry to implement inference processing associated with the object detector 100. The example machine-readable instructions and/or the example operations 900 of FIG. 9 begin at block 905, at which interface circuitry of the cluster selection circuitry 105 of the object detector 100 accesses an input 3D point cloud, such as the input 3D point cloud 115. At block 910, the cluster selection circuitry 105 selects one or more candidate clusters from the input 3D point cloud based on masks(s) and/or template(s), as described above. At block 915, the cluster selection circuitry 105 selects ones of the candidate clusters for downstream processing, as described above.

For example, at block 920, the cluster selection circuitry 105 inputs a given candidate cluster to the neural network circuitry 125 of the object detector 100, which outputs the feature vector 140 corresponding to the candidate cluster, as described above. At block 925, an object classification head implemented by the object classification head circuitry 130 of the object detector 100 processes the feature vector 140 to determine object classification parameter(s) for the candidate cluster, as described above. At block 930, one or more regression heads implemented by the regression head circuitry 135 of the object detector 100 process the feature vector 140 to determine bounding box parameter(s) for the candidate cluster, as described above.

At block 935, the cluster selection circuitry 105 continues to input candidate clusters to the neural network circuitry 125 until all candidate clusters have been processed. At block 940, the object detector 100 outputs the object classification parameter(s) and the bounding box parameter(s) determined for the respective candidate clusters. The example machine-readable instructions and/or the example operations 900 of FIG. 9 then end.

FIG. 10 is a flowchart representative of example machine readable instructions and/or example operations 1000 that may be executed, instantiated, and/or performed by programmable circuitry to train the object detector 100. The example machine-readable instructions and/or the example operations 1000 of FIG. 10 begin at block 1005, at which interface circuitry of the cluster selection circuitry 105 of the object detector 100 accesses training data. At block 1010, the cluster selection circuitry 105 selects one or more training clusters from the training, as described above. At block 1015, the cluster selection circuitry 105 cycles through the training clusters to enable training of the object detector 100.

For example, at block 1020, the cluster selection circuitry 105 inputs a given training cluster to the bounding box generation circuitry 155 of the object detector 100. At block 1020, the bounding box generation circuitry 155 determines a proposal bounding box for the training cluster, as described above. At block 1025, the regression calculation circuitry 160 of the object detector 100 determines, as described above, training bounding box regression parameters based on the proposal bounding box determined at block 1020 and a ground truth bounding box associated with the training cluster. For example, at block 1025, the regression calculation circuitry 160 can determine the training bounding box regression parameters based on Equations 1-7 provided above.

At block 1030, the cluster selection circuitry 105 also inputs the training cluster to the neural network circuitry 125 of the object detector 100, which outputs a feature vector corresponding to the training cluster, as described above. At block 1035, the feature vector is processed by the object classification head implemented by the object classification head circuitry 130 of the object detector to determine inference object classification parameters, as described above. At block 1035, the feature vector is also processed by the one or more regression head(s) implemented by the regression head circuitry 135 of the object detector to determine inference bounding box regression parameters, as described above.

At block 1040, the loss function evaluation circuitry 165 and the neural network update circuitry 170 of the object detector 100 operate, as described above, to train the neural network circuitry 125, the object classification head circuitry 130 and the regression head circuitry 135 based on the inference object classification parameters and the inference bounding box regression parameters determined at block 1035 and the training bounding box regression parameters determined at block 1025. For example, at block 1040, the loss function evaluation circuitry 165 can evaluate the loss functions of Equation 8-11 provided above, and the neural network update circuitry 170 can update the weights and/or parameters of the neural network circuitry 125, the object classification head circuitry 130 and the regression head circuitry 135 based on the loss function outputs, as described above.

At block 1045, the cluster selection circuitry 105 continues selecting training clusters to be used for training the object detector 100 until all training clusters have been processed, or until one or more other stopping criteria have been met. The example machine-readable instructions and/or the example operations 1000 of FIG. 10 then end.

FIG. 11 is a block diagram of an example programmable circuitry platform 1100 structured to execute and/or instantiate the example machine-readable instructions and/or the example operations of FIGS. 9 and/or 10 to implement the object detector 100. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the object detector 100 and/or, more specifically, one or more of the example cluster selection circuitry 105, the example object detection circuitry 120, the example neural network circuitry 125, the example object classification head circuitry 130, the example regression head circuitry 135, the example bounding box generation circuitry 155, the example regression calculation circuitry 160, the example loss function evaluation circuitry 165, the example neural network update circuitry 170, the example filter circuitry 205, the example overhead view projection circuitry 210, the example view fill circuitry 215, the example sample point selection circuitry 220, the example mask application circuitry 225, the example cluster identification circuitry 230, the example overhead view projection circuitry 605, the example bounding box fitting circuitry 610, the example mask generation circuitry 705 and/or the example template generation circuitry 710.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1120 operates to access the input 3D point cloud, such as the 3D point cloud 115, and/or the training data to be processed by the object detector 100.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 9 and/or 10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 9 and/or 10 to effectively instantiate the circuitry of FIG. 2 as logic circuits to perform operations corresponding to those machine readable instructions. In some such examples, the circuitry of FIG. 1 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 9 and/or 10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 9 and/or 10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 9 and/or 10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9 and/or 10. As such, the FPGA circuitry 1300 may be configured and/or structured to effectively instantiate some or all of the operations/functions corresponding to the machine readable instructions of the flowchart(s) of FIGS. 9 and/or 10 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 9 and/or 10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 9 and/or 10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 9 and/or 10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 9 and/or 10, and/or an ASIC may be configured and/or structured to perform third operation(s)/function(s) corresponding to a third portion of the machine readable instructions represented by the flowcharts of FIGS. 9 and/or 10.

It should be understood that some or all of the circuitry of FIG. 1 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 1 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

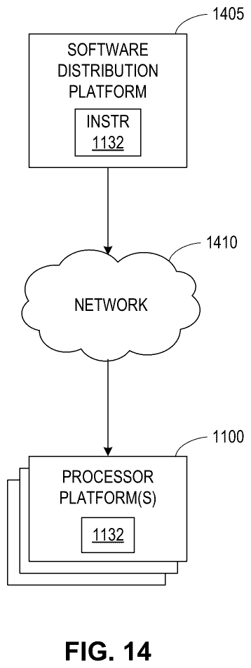

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 9 and/or 10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIGS. 9 and/or 10, may be downloaded to the example programmable circuitry platform 1100, which is to execute the machine readable instructions 1132 to implement the object detector 100. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that detect and locate objects in 3D point clouds. Disclosed systems, apparatus, articles of manufacture, and methods improve the efficiency of a computing device by focusing object detection and location processing on candidate cluster(s), rather than the entire 3D point cloud. As a result, the dimensionality and complexity of the neural network(s) and/or other machine learning architecture(s) that implement object detection and location processing can be reduced relative to neural network(s) and/or other machine learning architecture(s) that process the entire 3D point cloud. Such reduction in dimensionality and complexity can reduce power consumption, reduce computational resource requirements, improve the speed at which objects are detected and located, etc. Detecting objects faster can be extremely important in many applications, such as in autonomous vehicle navigation and/or other applications where collision avoidance and/or object interception is desired. By focusing object detection and location processing on candidate cluster(s) rather than the 3D point cloud as a whole, object classification and box regression accuracy can also be improved. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an object detection apparatus comprising interface circuitry to obtain a three-dimensional point cloud of a scene, machine readable instructions, and at least one processor circuit to be programmed by the machine readable instructions to apply at least one of a template or a mask at a sample point of an overhead view of the three-dimensional point cloud to identify a candidate cluster of points in the three-dimensional point cloud, the candidate cluster to satisfy an occupancy target, input the candidate cluster to a neural network, the neural network to output a feature vector for the candidate cluster, and process the feature vector to output parameters associated with an object classification and a bounding box for an object corresponding to the candidate cluster.

Example 2 includes the apparatus of example 1, wherein one or more of the at least one processor circuit is to apply the mask centered at the sample point of the overhead view of the three-dimensional point cloud, the mask associated with a particular object class, the mask corresponding to a grid map having grid locations with a first value or a second value, ones of the grid locations that correspond to the object classification to have the first value, ones of the grid locations that do not correspond to the object classification to have the second value, wherein the occupancy target corresponds to a target number of points of the candidate cluster to be covered by the mask.

Example 3 includes the apparatus of example 1 or example 2, wherein one or more of the at least one processor circuit is to apply the template centered at the sample point of the overhead view of the three-dimensional point cloud, the template associated with a particular object class, the template corresponding to a grid map having grid locations with respective values representative of numbers of points expected for the object classification at the grid locations.

Example 4 includes the apparatus of any of examples 1 to 3, wherein one of more of the at least one processor circuit is to implement an object classification head and a plurality of regression heads to output the parameters, the parameters include respective prediction values for a plurality of possible object classifications and respective sets of regression values associated with respective bounding boxes corresponding to the plurality of possible object classifications, the object classification head to output the respective prediction values for the plurality of possible object classifications, the plurality of regression heads to output the respective sets of regression values associated with the respective bounding boxes corresponding to the plurality of possible object classifications.

Example 5 includes the apparatus of any of examples 1 to 4, wherein a first one of the sets of regression values output by a first one of the regression heads corresponding to a first one of the possible object classifications includes values representative of differences between (i) a first one of the bounding boxes predicted by the first one of the regression heads based on the feature vector and (ii) a ground-truth bounding box corresponding to the first one of the possible object classifications.

Example 6 includes the apparatus of any of examples 1 to 5, wherein the three-dimensional point cloud is a first three-dimensional point cloud, the candidate cluster is a first candidate cluster, the parameters are first parameters, the interface circuitry is to obtain a second three-dimensional point cloud, and one or more of the at least one processor circuit is to select a second candidate cluster from the second three-dimensional point cloud, generate a proposal bounding box to cover a volume of the second candidate cluster, determine a first set of regression values representative of differences between the proposal bounding box and a ground-truth bounding box, input the second candidate cluster to the neural network, the neural network to output a second feature vector for the second candidate cluster, process the second feature vector with a plurality of heads to output parameters including a second set of regression values, determine an output of a loss function based on the first set of regression values and the second set of regression values, and update the neural network and the plurality of heads based on the output of the loss function.

Example 7 includes the apparatus of any of examples 1 to 6, wherein the first set of regression values includes a plurality of regression values representative of differences between a midpoint of the ground-truth bounding box and a midpoint of the proposal bounding box, a plurality of regression values representative of differences between dimensions of the ground-truth bounding box and dimensions of the proposal bounding box, and a regression value representative of a difference between an orientation of the ground-truth bounding box and an orientation of the proposal bounding box.

Example 8 includes the apparatus of any of examples 1 to 7, wherein the object classification is one of a plurality of possible object classifications, and one or more of the at least one processor circuit is to at least one of determine the mask based on a union of valid masks determined for a first one of the possible object classifications from ground-truth data, the valid masks selected based on an occupancy fraction computation, or determine the template based on a mean of valid templates determined for the first one of the possible object classifications from ground-truth data, the valid templates selected based on a normalized correlation coefficient computation.

Example 9 includes at least one non-transitory computer readable storage medium comprising instructions to cause at least one processor circuit to at least generate an overhead view of a three-dimensional point cloud, identify a candidate cluster of points in the three-dimensional point cloud based on at least one of a template or a mask applied at a sample point of the overhead view, the candidate cluster to satisfy an occupancy target, and output parameters associated with an object classification and a bounding box for an object corresponding to the candidate cluster, the parameters based on the candidate cluster.

Example 10 includes the least one non-transitory computer readable storage medium of example 9, wherein the instructions are to cause one or more of the at least one processor circuit to implement a neural network trained to output a feature vector based on the candidate cluster, the parameters based the feature vector.

Example 11 includes the least one non-transitory computer readable storage medium of example 9 or example 10, wherein the parameters include object classification probabilities for respective ones of a plurality of possible object classifications, and the instructions are to cause one or more of the at least one processor circuit to implement an object classification head to process the feature vector to determine the object classification probabilities.

Example 12 includes the least one non-transitory computer readable storage medium of any of examples 9 to 11, wherein the parameters include sets of bounding box regression values corresponding to respective ones of the plurality of possible object classifications, and the instructions are to cause one or more of the at least one processor circuit to implement a plurality of regression heads corresponding respectively to the plurality of possible object classifications, respective ones of the regression heads to process the feature vector to determine respective ones of the sets of bounding box regression values.

Example 13 includes the least one non-transitory computer readable storage medium of any of examples 9 to 12, wherein a first one of the regression heads corresponds to a first one of the possible object classifications, and the instructions are to cause one or more of the at least one processor circuit to implement the first one of the regression heads to process the feature vector to determine a first one of the sets of bounding box regression values, the first one of the sets of bounding box regression values including values representative of differences between (i) a first one of the bounding boxes predicted by the first one of the regression heads based on the feature vector and (ii) a ground-truth bounding box corresponding to the first one of the possible object classifications.

Example 14 includes the least one non-transitory computer readable storage medium of any of examples 9 to 13, wherein the three-dimensional point cloud is a first three-dimensional point cloud, the candidate cluster is a first candidate cluster, and the instructions are to cause one or more of the at least one processor circuit to select a second candidate cluster from a second three-dimensional point cloud, generate a proposal bounding box to cover a volume of the second candidate cluster, determine a set of regression values representative of differences between the proposal bounding box and a ground-truth bounding box, and train one or more machine learning algorithms based on the set of regression values, the one or more machine learning algorithms to determine the parameters based on the candidate cluster.

Example 15 includes a method comprising identifying, by at least one processor circuit programmed by at least one instruction, a candidate cluster of points in the three-dimensional point cloud based on at least one of a template or a mask applied at a sample point of an overhead view of the three-dimensional point cloud, the candidate cluster to satisfy an occupancy target, processing the candidate cluster with a neural network to output a feature vector for the candidate cluster, and outputting parameters associated with an object classification and a bounding box for an object corresponding to the candidate cluster, the parameters based on the feature vector.

Example 16 includes the method of example 15, further including processing the feature vector with an object classification head to determine a plurality of object classification probabilities corresponding respectively to a plurality of possible object classifications.

Example 17 includes the method of example 15 or example 16, further including processing the feature vector with a plurality of regression heads to determine a plurality of sets of bounding box regression values corresponding respectively to a plurality of possible object classifications, respective ones of the regression heads corresponding to respective ones of the possible object classifications.

Example 18 includes the method of any of examples 15 to 17, wherein a first one of the regression heads corresponds to a first one of the possible object classifications, and the processing of the feature vector with the plurality of regression heads includes processing the feature vector with the first one of the regression heads to determine a first one of the sets of bounding box regression values, the first one of the sets of bounding box regression values including values representative of differences between (i) a first one of the bounding boxes predicted by the first one of the regression heads based on the feature vector and (ii) a ground-truth bounding box corresponding to the first one of the possible object classifications.

Example 19 includes the method of any of examples 15 to 18, wherein the three-dimensional point cloud is a first three-dimensional point cloud, the candidate cluster is a first candidate cluster, and further including selecting a second candidate cluster from a second three-dimensional point cloud, generating a proposal bounding box to cover a volume of the second candidate cluster, determining a set of regression values representative of differences between the proposal bounding box and a ground-truth bounding box, and training the neural network based on the set of regression values.

Example 20 includes the method of any of examples 15 to 19, the set of regression values includes a plurality of regression values representative of differences between a midpoint of the ground-truth bounding box and a midpoint of the proposal bounding box, a plurality of regression values representative of differences between dimensions of the ground-truth bounding box and dimensions of the proposal bounding box, and a regression value representative of a difference between an orientation of the ground-truth bounding box and an orientation of the proposal bounding box.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An object detection apparatus comprising:
interface circuitry to obtain a three-dimensional point cloud of a scene;
machine readable instructions; and
at least one processor circuit to be programmed by the machine readable instructions to:
apply at least one of a template or a mask at a sample point of an overhead view of the three-dimensional point cloud to identify a candidate cluster of points in the three-dimensional point cloud, the candidate cluster to satisfy an occupancy target;
input the candidate cluster to a neural network, the neural network to output a feature vector for the candidate cluster; and
process the feature vector to output parameters associated with an object classification and a bounding box for an object corresponding to the candidate cluster.

2. The apparatus of claim 1, wherein one or more of the at least one processor circuit is to apply the mask centered at the sample point of the overhead view of the three-dimensional point cloud, the mask associated with a particular object class, the mask corresponding to a grid map having grid locations with a first value or a second value, ones of the grid locations that correspond to the object classification to have the first value, ones of the grid locations that do not correspond to the object classification to have the second value, wherein the occupancy target corresponds to a target number of points of the candidate cluster to be covered by the mask.

3. The apparatus of claim 1, wherein one or more of the at least one processor circuit is to apply the template centered at the sample point of the overhead view of the three-dimensional point cloud, the template associated with a particular object class, the template corresponding to a grid map having grid locations with respective values representative of numbers of points expected for the object classification at the grid locations.

4. The apparatus of claim 1, wherein one of more of the at least one processor circuit is to implement an object classification head and a plurality of regression heads to output the parameters, the parameters include respective prediction values for a plurality of possible object classifications and respective sets of regression values associated with respective bounding boxes corresponding to the plurality of possible object classifications, the object classification head to output the respective prediction values for the plurality of possible object classifications, the plurality of regression heads to output the respective sets of regression values associated with the respective bounding boxes corresponding to the plurality of possible object classifications.

5. The apparatus of claim 4, wherein a first one of the sets of regression values output by a first one of the regression heads corresponding to a first one of the possible object classifications includes values representative of differences between (i) a first one of the bounding boxes predicted by the first one of the regression heads based on the feature vector and (ii) a ground-truth bounding box corresponding to the first one of the possible object classifications.

6. The apparatus of claim 1, wherein the three-dimensional point cloud is a first three-dimensional point cloud, the candidate cluster is a first candidate cluster, the parameters are first parameters, the interface circuitry is to obtain a second three-dimensional point cloud, and one or more of the at least one processor circuit is to:
select a second candidate cluster from the second three-dimensional point cloud;
generate a proposal bounding box to cover a volume of the second candidate cluster;
determine a first set of regression values representative of differences between the proposal bounding box and a ground-truth bounding box;
input the second candidate cluster to the neural network, the neural network to output a second feature vector for the second candidate cluster;
process the second feature vector with a plurality of heads to output parameters including a second set of regression values;
determine an output of a loss function based on the first set of regression values and the second set of regression values; and
update the neural network and the plurality of heads based on the output of the loss function.

7. The apparatus of claim 6, wherein the first set of regression values includes:
a plurality of regression values representative of differences between a midpoint of the ground-truth bounding box and a midpoint of the proposal bounding box;
a plurality of regression values representative of differences between dimensions of the ground-truth bounding box and dimensions of the proposal bounding box; and
a regression value representative of a difference between an orientation of the ground-truth bounding box and an orientation of the proposal bounding box.

8. The apparatus of claim 1, wherein the object classification is one of a plurality of possible object classifications, and one or more of the at least one processor circuit is to at least one of:
determine the mask based on a union of valid masks determined for a first one of the possible object classifications from ground-truth data, the valid masks selected based on an occupancy fraction computation; or
determine the template based on a mean of valid templates determined for the first one of the possible object classifications from ground-truth data, the valid templates selected based on a normalized correlation coefficient computation.

9. At least one non-transitory computer readable storage medium comprising instructions to cause at least one processor circuit to at least:
generate an overhead view of a three-dimensional point cloud;
identify a candidate cluster of points in the three-dimensional point cloud based on at least one of a template or a mask applied at a sample point of the overhead view, the candidate cluster to satisfy an occupancy target; and
output parameters associated with an object classification and a bounding box for an object corresponding to the candidate cluster, the parameters based on the candidate cluster.

10. The least one non-transitory computer readable storage medium of claim 9, wherein the instructions are to cause one or more of the at least one processor circuit to implement a neural network trained to output a feature vector based on the candidate cluster, the parameters based the feature vector.

11. The least one non-transitory computer readable storage medium of claim 10, wherein the parameters include object classification probabilities for respective ones of a plurality of possible object classifications, and the instructions are to cause one or more of the at least one processor circuit to implement an object classification head to process the feature vector to determine the object classification probabilities.

12. The least one non-transitory computer readable storage medium of claim 11, wherein the parameters include sets of bounding box regression values corresponding to respective ones of the plurality of possible object classifications, and the instructions are to cause one or more of the at least one processor circuit to implement a plurality of regression heads corresponding respectively to the plurality of possible object classifications, respective ones of the regression heads to process the feature vector to determine respective ones of the sets of bounding box regression values.

13. The least one non-transitory computer readable storage medium of claim 12, wherein a first one of the regression heads corresponds to a first one of the possible object classifications, and the instructions are to cause one or more of the at least one processor circuit to implement the first one of the regression heads to process the feature vector to determine a first one of the sets of bounding box regression values, the first one of the sets of bounding box regression values including values representative of differences between (i) a first one of the bounding boxes predicted by the first one of the regression heads based on the feature vector and (ii) a ground-truth bounding box corresponding to the first one of the possible object classifications.

14. The least one non-transitory computer readable storage medium of claim 9, wherein the three-dimensional point cloud is a first three-dimensional point cloud, the candidate cluster is a first candidate cluster, and the instructions are to cause one or more of the at least one processor circuit to:
select a second candidate cluster from a second three-dimensional point cloud;
generate a proposal bounding box to cover a volume of the second candidate cluster;
determine a set of regression values representative of differences between the proposal bounding box and a ground-truth bounding box; and
train one or more machine learning algorithms based on the set of regression values, the one or more machine learning algorithms to determine the parameters based on the candidate cluster.

15. A method comprising:
identifying, by at least one processor circuit programmed by at least one instruction, a candidate cluster of points in the three-dimensional point cloud based on at least one of a template or a mask applied at a sample point of an overhead view of the three-dimensional point cloud, the candidate cluster to satisfy an occupancy target;
processing the candidate cluster with a neural network to output a feature vector for the candidate cluster; and
outputting parameters associated with an object classification and a bounding box for an object corresponding to the candidate cluster, the parameters based on the feature vector.

16. The method of claim 15, further including processing the feature vector with an object classification head to determine a plurality of object classification probabilities corresponding respectively to a plurality of possible object classifications.

17. The method of claim 15, further including processing the feature vector with a plurality of regression heads to determine a plurality of sets of bounding box regression values corresponding respectively to a plurality of possible object classifications, respective ones of the regression heads corresponding to respective ones of the possible object classifications.

18. The method of claim 17, wherein a first one of the regression heads corresponds to a first one of the possible object classifications, and the processing of the feature vector with the plurality of regression heads includes processing the feature vector with the first one of the regression heads to determine a first one of the sets of bounding box regression values, the first one of the sets of bounding box regression values including values representative of differences between (i) a first one of the bounding boxes predicted by the first one of the regression heads based on the feature vector and (ii) a ground-truth bounding box corresponding to the first one of the possible object classifications.

19. The method of claim 15, wherein the three-dimensional point cloud is a first three-dimensional point cloud, the candidate cluster is a first candidate cluster, and further including:
selecting a second candidate cluster from a second three-dimensional point cloud;
generating a proposal bounding box to cover a volume of the second candidate cluster;
determining a set of regression values representative of differences between the proposal bounding box and a ground-truth bounding box; and
training the neural network based on the set of regression values.

20. The method of claim 19, the set of regression values includes:
a plurality of regression values representative of differences between a midpoint of the ground-truth bounding box and a midpoint of the proposal bounding box;
a plurality of regression values representative of differences between dimensions of the ground-truth bounding box and dimensions of the proposal bounding box; and
a regression value representative of a difference between an orientation of the ground-truth bounding box and an orientation of the proposal bounding box.
